(19) United States
(12) Patent Application Publication
(10) Pub. No.: US 2025/0293825 A1
(43) Pub. Date: Sep. 18, 2025

(54) IDENTIFYING VICTIM AND AGGRESSOR USER EQUIPMENT

(71) Applicant: Apple Inc., Cupertino, CA (US)

(72) Inventors: Seyed Ali Akbar Fakoorian, San Diego, CA (US); Chunhai Yao, Beijing (CN); Chunxuan Ye, San Diego, CA (US); Dawei Zhang, Saratoga, CA (US); Haitong Sun, Saratoga, CA (US); Oghenekome Oteri, San Diego, CA (US); Wei Zeng, Saratoga, CA (US); Xiang Chen, Campbell, CA (US); Yang Tang, San Jose, CA (US); Yushu Zhang, Beijing (CN)

(73) Assignee: Apple Inc., Cupertino, CA (US)

(21) Appl. No.: 18/861,152

(22) PCT Filed: Apr. 20, 2023
(86) PCT No.: PCT/US2023/019304

§ 371 Date: Oct. 28, 2024

Related U.S. Application Data
(60) Provisional application No. 63/336,696, filed on Apr. 29, 2022.

(51) Int. Cl. H04L 5/00; H04W 72/23

(52) U.S. Cl. CPC H04L 5/0048; H04W 72/23

(57) ABSTRACT

Aspects of the disclosure include methods for identifying a potential victim user equipment (UE). An exemplary method includes receiving a message with an indication to transmit a sounding reference signal (SRS) prior to a physical downlink shared channel (PDSCH) transmission. The PDSCH transmission being scheduled with a first transmission parameter that is a start and length indicator value (SLIV), a priority, a timing advance, or a number of repetitions. The method further includes selecting, from an activated SRS resource set, an SRS resource that has a second transmission parameter that is associated with the first transmission parameter. The method further includes transmitting the SRS via the SRS resource.

### CROSS-REFERENCE TO RELATED APPLICATION

This application claims priority to U.S. Provisional Application No. 63/336,696, filed Apr. 29, 2022. The contents of said application is hereby incorporated by reference in its entirety.

### FIELD

The present application relates to the field of wireless networks and, in particular, to identifying victim and aggressor user equipment.

### BACKGROUND

Cellular communications can be defined in various standards to enable communications between a user equipment and a cellular network. For example, the Fifth generation mobile network (5G) is a wireless standard that aims to improve upon data transmission speed, reliability, availability, and more.

### BRIEF DESCRIPTION OF THE DRAWINGS

FIG. 1 illustrates an example of a network architecture that incorporates both Third generation partnership project (3GPP) (e.g., cellular) and non-3GPP (e.g., non-cellular) access to a core network (CN), in accordance with some embodiments.

FIG. 2 illustrates an example of a network architecture that incorporates both dual 3GPP access and non-3GPP access to the CN, in accordance with some embodiments

FIG. 3 illustrates an example system for transmitting a sounding reference signal (SRS) for a clear to send (CTS) purpose, in accordance with some embodiments.

FIG. 4 illustrates example timing constraints for using an SRS configured for a CTS purpose in accordance with some embodiments.

FIG. 5 illustrates example timing constraints for using a semi-persistently scheduled SRS configured for a CTS purpose in accordance with some embodiments.

FIG. 6 illustrates an SRS resource set configured for a CTS purpose in accordance with some embodiments.

FIG. 7 illustrates an example system for transmitting an SRS for a CTS purpose, in accordance with some embodiments.

FIG. 8 illustrates a signaling diagram for transmitting an SRS for a CTS purpose, in accordance with some embodiments.

FIG. 9 illustrates a signaling diagram for determining whether to transmit a scheduled physical uplink shared channel (PUSCH) transmission, in accordance with some embodiments.

FIG. 10 illustrates a process for transmitting an SRS for a CTS purpose, in accordance with some embodiments.

FIG. 11 illustrates a process for determining whether to transmit a scheduled PUSCH transmission, in accordance with some embodiments

FIG. 12 illustrates a process for transmitting an indication to transmit an SRS for a CTS purpose and an indication for measuring the SRS for the CTS purpose, in accordance with some embodiments.

FIG. 13 illustrates an example of receive components, in accordance with some embodiments.

FIG. 14 illustrates an example of a user equipment (UE), in accordance with some embodiments.

FIG. 15 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. In order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Full-duplex and half-duplex are spectrum management techniques that a network can use to enable two-way communication between nodes. Full-duplex technology facilitates simultaneous communication between network nodes, whereas half-duplex technology facilities one-directional communication between network nodes. Full-duplex can be implemented via various schemes, such as frequency division duplexing (FDD). FDD enables network nodes to transmit and receive data simultaneously over separate frequency bands. Time division duplexing (TDD) enables network nodes to transmit and receive data over the same frequency band but during alternating time blocks.

In some instances, full-duplex operation may occur within a TDD band to enhance uplink coverage. Full duplex operation may refer to the case in which a base station is operating in full-duplex, for example, simultaneously transmitting and receiving. In some networks, a UE may operate with half-duplex, while the base station engages in full-duplex operation on non-overlapping subbands only in TDD bands.

One issue with a full-duplex (FD) mode is that an aggressor node's data transmission can interfere with the reception of data by a victim node. Consider an example in which a base station is in operable communication with a potential victim user equipment (UE) and a potential aggressor UE. The victim UE can be scheduled to receive a downlink transmission, and the aggressor UE can be scheduled to send an uplink transmission. Both transmissions can be scheduled to be sent via nearby sub-bands in time and frequency. If the two UEs are spatially correlated, then there is an aggressor UE to victim UE cross link interference (CLI) case. CLI can occur when the aggressor UE is transmitting over a frequency band nearby to the frequency band over which the victim EU is receiving. The potential aggressor UE's uplink transmission can interfere with the potential victim UE's downlink transmission. If, however, the two UEs are spatially separated, then the potential aggressor UE's uplink transmission is not likely to interfere with the potential victim UE's downlink transmission.

Conventional interference mitigation techniques presume interference, and therefore the UEs will be required to implement these techniques regardless of the likelihood of interference. For example, one technique is to reduce the antenna transmission power of the potential aggressor UE. However, if there is no potential victim UE, then applying reduced power constraint on the potential aggressor UE (e.g., simply relying on the downlink (DL) and uplink physical resources blocks (PRBs) respectively allocated to victim/aggressor UEs) may under-optimized resources used by the potential aggressor UE. Another technique is to increase the width of a guard band between the downlink frequency band and the uplink frequency band. Each of these techniques is unnecessary in instances that a UE's transmission is not likely to interfere with another UE's transmission. However, these techniques are utilized because it can be difficult to preemptively identify a potential victim UE. Additionally, even if a potential victim UE is identified, it is difficult to determine how to regulate the potential aggressor UE to prevent the interference.

Embodiments disclosed herein are directed to addressing the above-described issues. A potential victim UE can transmit a sounding reference signal (SRS) prior to a scheduled physical downlink shared channel (PDSCH) transmission. The SRS can be configured for a clear to send (CTS) purpose. A potential aggressor UE can measure the SRS prior to a physical uplink shared channel (PUSCH) transmission. The potential aggressor UE can determine whether the PUSCH transmission can interfere with the PDSCH transmission. The potential aggressor UE can then determine whether to proceed or delay the PUSCH transmission based on the interference determination.

Embodiments of the present disclosure are described in connection with 5G networks. However, the embodiments are not limited as such and similarly apply to other types of communication networks, including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein refers to a communications network that includes a set of network nodes configured to provide communications functions to a plurality of user equipment via one or more base stations. For instance, the network can be a public land mobile network (PLMN) that implements one or more communication technologies, including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element” as used herein refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types of non-cellular access technologies.

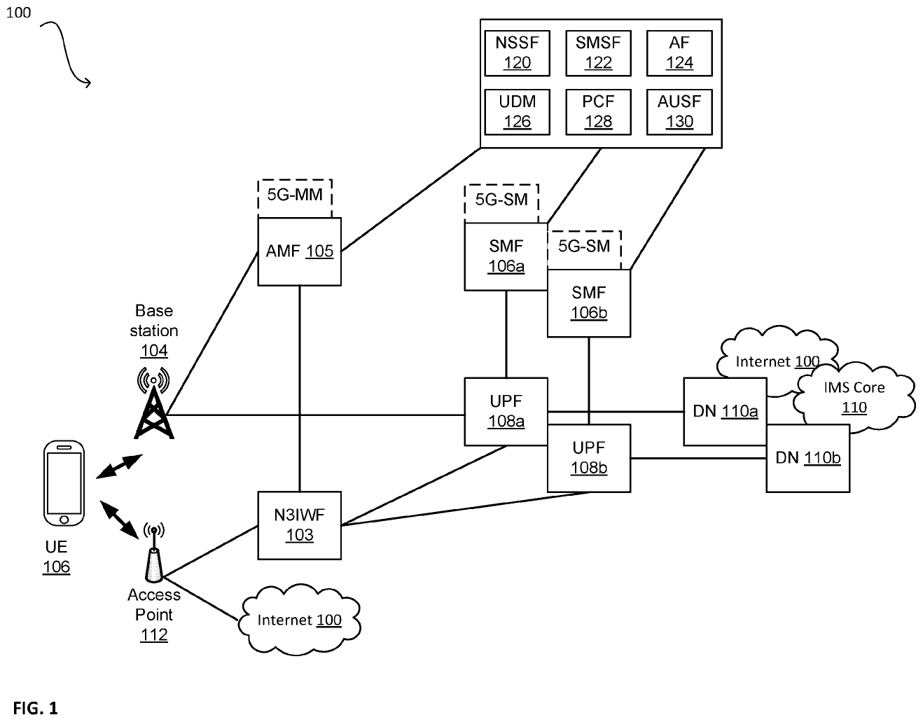

FIG. 1 illustrates an example of a 5G network architecture that incorporates both 3GPP (e.g., cellular) and non-3GPP (e.g., non-cellular) access to a 5G core network (CN) in accordance with some embodiments. As shown, a UE 106 may access the 5G CN through both a radio access network (RAN, e.g., a base station 104 that can be a gNB) and an access point (AP) 112. The AP 112 may include a connection to the Internet 100 as well as a connection to a non-3GPP inter-working function (N3IWF) 103 network entity. The N3IWF may include a connection to a core access and mobility management function (AMF) 105 of the 5G CN. The AMF 105 may include an instance of a 5G mobility management (5G MM) function associated with the UE 106. In addition, the RAN (e.g., the base station 104) may also have a connection to the AMF 105. Thus, the 5G CN may support unified authentication over both connections as well as allow simultaneous registration for UE 106 access via both gNB 104 and AP 112. As shown, the AMF 105 may include one or more functional entities associated with the 5G CN (e.g., network slice selection function (NSSF) 120, short message service function (SMSF) 122, application function (AF) 124, unified data management (UDM) 126, policy control function (PCF) 128, or authentication server function (AUSF) 130). Note that these functional entities may also be supported by a session management function (SMF) 106a and an SMF 106b of the 5G CN. The AMF 105 may be connected to (or in communication with) the SMF 106a. Further, the base station 104 may be in communication with (or connected to) a user plane function (UPF) 108a that may also be in communication with the SMF 106a. Similarly, the N3IWF 103 may be communicating with a UPF 108b that may also be communicating with the SMF 106b. Both UPFs may be communicating with the data network (e.g., DN 110a and 110b) or the Internet 100 and Internet Protocol (IP) Multimedia Subsystem/IP Multimedia Core Network Subsystem (IMS) core network 110.

Generally, base station 104 communicates over a transmission medium with one or more UEs (e.g., including the UE 106). Each of the user devices may be referred to herein as a “user equipment” (UE). The base station (BS) 104 may be a base transceiver station (BTS) or cell site (a “cellular base station”) and may include hardware that enables wireless communication with the UE 106.

The communication area (or coverage area) of the base station 104 may be referred to as a “cell.” The base station 104 and the UE 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. If the base station 104 is implemented in the context of LTE, it may alternately be referred to as an ‘eNodeB’ or ‘eNB’. If the base station 104 is implemented in the context of 5G NR, it may alternately be referred to as ‘gNodeB’ or ‘gNB’.

The base station 104 may also be equipped to communicate with a network (e.g., a core network of a cellular service provider, such as the 5G CN, a telecommunication network, such as a public switched telephone network (PSTN), or the Internet, among various possibilities). Thus, the base station 104 may facilitate communication between the user devices or between the UE 106 and the network. In particular, the cellular base station 104 may provide UEs 106 with various telecommunication capabilities, such as voice, SMS, or data services.

The base station 104 and other similar base stations operating according to the same or a different cellular communication standard may thus be provided as a network of cells, which may provide continuous or nearly continuous overlapping service to UE 106 and similar devices over a geographic area via one or more cellular communication standards.

Thus, while base station 104 may act as a “serving cell” for UE 106, as illustrated in FIG. 1, the UE 106 may also be capable of receiving signals from (and possibly within communication range of) one or more other cells, which may be referred to as “neighboring cells.” Such cells may also be capable of facilitating communication between user devices or between user devices and the network 100. Such cells may include “macro” cells, “micro” cells, “pico” cells, or cells that provide any of various other granularities of service area size.

In some embodiments, the base station 104 may be a next generation base station, e.g., a 5G New Radio (5G NR) base station, or “gNB”. In some embodiments, a gNB may also be connected to a legacy evolved packet core (EPC) network or to a NR core (NRC) network. In addition, a gNB cell may include one or more transition and reception points (TRPs). In addition, a UE capable of operating according to 5G NR may be connected to one or more TRPs within one or more gNBs.

The UE 106 may be capable of communicating using multiple wireless communication standards. For example, the UE 106 may be configured to communicate using a wireless networking (e.g., Wi-Fi) or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), or any other wireless communication protocol, if desired. Other combinations of wireless communication standards (including more than two wireless communication standards) are also possible.

FD operations within a TDD band will be studied as part 3GPP release 18 enhancement. In particular, an FD operation that aims to use FDD in a TDD band, at least to enhance UL coverage. In 3GPP RAN #93-e, FD operation was further discussed, and in 3GPP RAN #94-e, it was that the 3GPP release 18 enhancement should assume a half-duplex UE, and FD operation on non-overlapping sub-bands at a base station only in a TDD band.

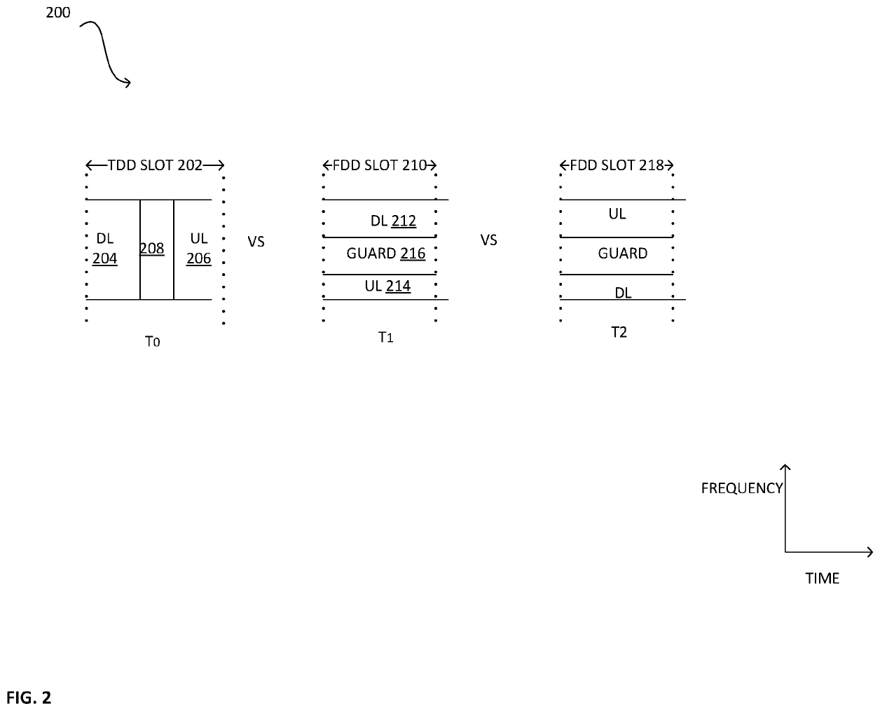

FIG. 2 is an illustration of a TDD slot 202 at T₀. is shown. As shown, at any given time, RAN resources are configured for a DL time band 204, or a UL time band 206. As illustrated a guard band 208 is arranged between the DL transmission 204 and the UL transmission 206. A UE does not transmit or receive during a time interval associated with the guard band 208. It can be seen that there is no time that a UE can simultaneously transmit and receive.

It would, however, be desirable to for a UE to mimic an FDD mode. For example, it would be desirable for a UE to operate as illustrated in the FDD slot 210 at T₁. As seen, RAN resources can be configured for a DL transmission in a DL frequency band 212, and for UL transmission in a UL frequency band 214. As illustrated a guard band 216 is arranged between the DL frequency band 212 and the UL frequency band 214. As with TDD slot 202, the guard band 216 helps minimize interference between a UL transmission and an DL transmission. FDD slot 218 at T₂ is similar to FDD slot 210 with the exception that the UL DL frequency have been reversed.

In 3GPP release 18, half-duplex UEs that are camping in a cell operating in a DF mode will ideally have minimum specification impact. Referring to FIG. 2, consider an example, a T₀ a cell is performing a legacy half-duplex operation, and therefore all of the UEs in the cell assume a legacy TDD slot. At T₁ (or T₂), the cell is performing a FD operation. The UE's currently receiving a DL transmission and the UEs currently transmitting a UL transmission still assume TDD slots (with all symbols usable for DL or UL, respectively). Even though the UEs assuming DL or UL, a UE transmission via a FDD slot can impact a UE receiving a DL transmission.

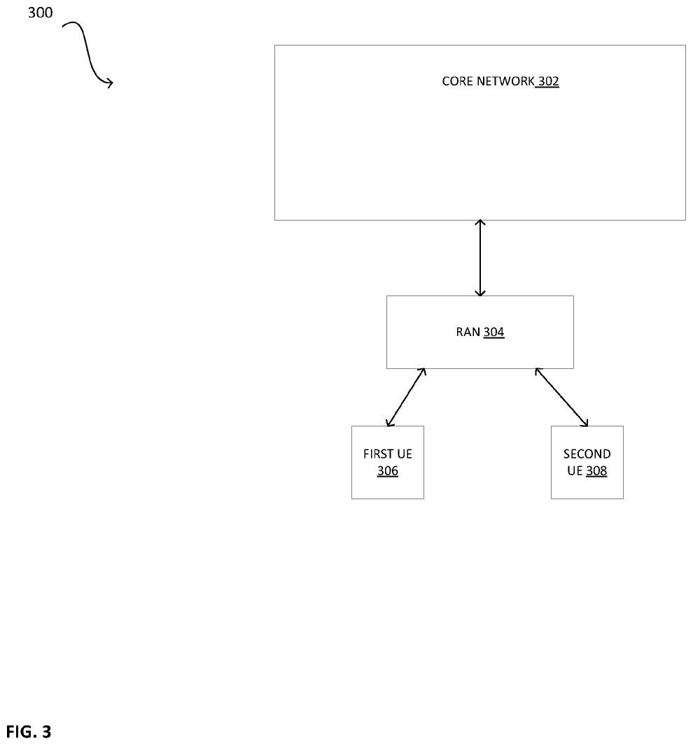

FIG. 3 illustrates an example 5G system 300 in accordance with some embodiments. As illustrated, a CN 302 can interface with a RAN 304. It should be appreciated that the CN 302 can be a sixth generation (6G) CN in that a 6G CN architecture is comparable with a 5G CN architecture. The RAN 304 can be included in a set of base stations that collectively form a radio area network (RAN) that interfaces with the CN 302. The RAN 304 can perform various functions including transmitting user data to a UE. A base station of the RAN 304 can further communicate with other base stations either directly or indirectly over backhaul links.

Base stations of the RAN 304 can be in operable communication with a first UE 306 and a second UE 308. The first UE 306 and the second UE 308 can be supported by the RAN 304. The communication between the RAN 304 and the first UE 306 and the second UE 308 can include an uplink (UL) transmission, including a transmission from either the first UE 306 or second UE 308 to the RAN 304. The communication can also include a DL transmission from the RAN 304 to either the first UE 306 or the second UE 308.

The RAN 304 can be configured to send a DL transmission with information to assist a potential aggressor UE to identify a potential victim UE. The RAN 304 can transmit an indication to the first UE 306, to transmit an SRS for a CTS purpose prior to a scheduled physical downlink shared channel (PDSCH) transmission. The SRS is designated for a CTS purpose to help minimize CLI between a potential aggressor UE and a potential victim UE. The indication can be included in downlink control information (DCI), for example, the DCI used to schedule the PDSCH transmission. In some embodiments, the DCI can include one or more bits of an SRS bit-field that can activate an SRS resource set configured for a clear to send (CTS) purpose. The DCI can further activate an SRS resource set configured for a CTS purpose.

In other embodiments, the RAN 304 can tag an SRS resource set with a radio resource control (RRC) flag. The RRC can be a layer in a protocol stock executing in the RAN 304. Similar to the SRS bit-field included in the DCI, the RRC flag can be an indication to a UE to transmit an SRS for a clear to send (CTS) purpose prior to a scheduled PDSCH transmission and activate an SRS resource set configured for a CTS purpose.

An SRS resource set can include multiple SRS resources that can be used by the first UE 306 to transmit the SRS. Each SRS resource of the SRS resource set can include a collection of resource elements. The resource elements can span multiple physical resource blocks (PRBs) in the frequency domain, and consecutive symbols in the time domain. An SRS resource can include one more antenna ports and associated comb pattern, and can span specific symbols and PRBs in the frequency domain.

As described herein, each SRS resource of an activated SRS resource set can carry one or more parameters regarding a scheduled PDSCH transmission to the first UE 306. For example, one SRS resource of the SRS resource set can be configured to convey that the scheduled PDSCH transmission as a high priority transmission, wherein another SRS resource of the SRS resource set is configured to convey that the scheduled PDSCH transmission as a low priority transmission. The first UE 306 can select the SRS resource from the SRS resource set that includes a parameter that describes a particular scheduled PDSCH transmission. The RAN 304 can configure the first UE 306 with an SRS resource set that generically includes parameters that can be associated with a scheduled PDSCH transmission. The first UE 306 can then select the SRS resource that carries information to best represent the scheduled PDSCH transmission. In some other embodiments, the RAN 304 can configure the first UE 306 with an SRS resource set for a CTS purpose based on a particular scheduled PDSCH transmission. For example, the RAN 304 can configure the first UE 306 with an SRS resource set to transmit an SRS in the first x-symbols of the slot prior to the PDSCH transmission slot. In other embodiments, the PDSCH transmission is a semi-persistent scheduled PDSCH (SPS-PDSCH) transmission. In these embodiments, the RAN 304 can periodically configure the first UE 306 with an SRS resource set to transmit the SRS.

Each SRS resource set can include one or more SRS resources usable by the first UE 306 to transmit the SRS. As described above, the SRS resource can include information regarding a first parameter related to a scheduled PDSCH transmission. The first parameter can include, for example, and length indicator value (SLIV), a priority, a timing advance, or a number of repetitions of a scheduled PDSCH transmission. For example, a first SRS resource indicates a SLIV from symbol 7 to symbol 13 of a slot, and a high priority. A second SRS resource indicates a SLIV from symbol 7 to symbol 13, and a low priority. A third SRS resource indicates a SLIV from symbol 0 to symbol 6, and a high priority. A fourth SRS resource indicates a SLIV from symbol 0 to symbol 6, and a low priority.

The first UE 306 can receive an indication from the RAN 304 to transmit the SRs prior to a scheduled PDSCH transmission. The UE 306 can further detect the activated SRS resource set and determine that the SRS is for a CTS purpose. The first UE 306 can detect a first parameter of the scheduled PDSCH transmission. The first UE 306 can select an SRS resource of the activated SRS resource set based on the first parameter relating a second parameter carried by the SRS resource. The first UE 306 can select an SRS resource from the activated SRS resource set based on which SRS resource best describes the scheduled PDSCH transmission. In some embodiments, the first UE 306 selects a single SRS resource of the SRS resource set. This is in contrast to non-CTS operations, in which the first UE 306 can transmit an SRS over all SRS resources of an activated SRS resource set.

In some instances, the SRS transmitted by the first UE 306 can overlap in the time domain with an ongoing UL transmission of another UE, such as the second UE 308. The SRS can have a higher or lower priority than the priority of the UL transmission of the second UE 308. The second UE 308 can detect the SRS and determine a priority of the SRS in relation to the ongoing UL transmission. If SRS has a higher priority than the UL transmission, the other second UE 308 can drop the UL transmission. If, however, the SRS has a lower priority than the UL transmission, the second UE 308 can continue with the UL transmission.

The RAN 304 can send an indication to the second UE 308 to measure an SRS, such as the SRS transmitted by the first UE 306. For example, an SRS request bit-field can activate an SRs resource set. The second UE 308 can detect the activated SRS resource set and determine that the SRS is for a CTS purpose based on a configuration of SRS resource set. The second UE 308 can measure the SRS to determine whether to send or refrain from sending the scheduled PUSCH transmission. It should be appreciated that in contrast to the current specification, in which SRS resource activation indicates SRS transmission, as described here, SRS resource activation is an indication to measure the SRS. The second UE 308 can use various measurement techniques to measure the SRS, such as a CLI received signal strength indicator (CLI-RSSI) technique and SRS reference signal received power (SRS-RSRP). A CLI-RSSI technique is the calculation of the total received wide-band power measured over an entire bandwidth. An SRS-RSRP technique is the calculation of the linear average of reference signal power measure over a specified bandwidth. The decision as to which technique to use to measure the SRS can be indicated by the RAN 304. If, for example, multiple UEs transmit SRSs using the same SRS resource, the RAN 304 can indicate to the second UE 308 to use CLI-RSSI technique. If, however, a single UE is transmitting an SRS using the SRS resource, the RAN 304 can indicate to the second UE 308 to use the SRS-RSRP technique.

The measured SRS can include a parameter related to a scheduled PDSCH transmission. The parameter can include, for example, a SLIV, a priority, a timing advance, or a number of repetitions of a PDSCH. As described above, in some embodiments, the first UE 306 transmits the SRS using a single SRS resource. However, the second UE 308 performs measurements over all of the SRS resources of an activated SRS resource set. This is due to the second UE 308 not receiving information regarding how many UEs have transmitted an SRS configured for a CTS purpose.

In some embodiments, the RAN 304 configures the second UE 308 with generic SRS resources that conform to generic SRS resources associated with the first UE 306. Therefore, if the second UE 308 measures over multiple SRS resources, and different UE's are transmitting SRSs, the SRS resource set conforms to the same PDSCH parameters regardless of the transmitting UE. In other embodiments, the RAN 304 configures the second UE 308 with SRS resources based on a specific PUSCH transmission. For example, the RAN 304 configures the second UE 308 with SRS resources based on the first y-symbols of the slot prior to the scheduled PUSCH transmission slot. In yet other embodiments, the PUSCH transmission is a periodic transmission. In these instances, the RAN 304 can periodically configure the second UE 308 with SRS resources.

In some embodiments, a RAN (e.g., RAN 304) can operate in a dynamic TDD mode such that a base station can dynamically assign and reassign time domain resources between UL and DL transmission. Furthermore, from time to time, a base station in one cell can schedule a UL transmission for a UE that interferes with a scheduled DL transmission of another UE. For example, a base station in a first cell can schedule a PUSCH for a UE, and a neighboring base station in a second cell can have previously scheduled a PDSCH for another UE in that time slot. Using the method described here, each base station can transmit indications, (e.g., via the DCI or RRC information) to have one UE transmit an SRS configured for a CTS purpose, and the other UE to measure the SRS. In other words, the DCI information or RRC information does not need to originate from the same base station, and the UEs can be served by different base stations in different cells of a network.

The RAN 304 can further indicate to the second UE 308 to map measured values to actions, such as sending a PUSCH transmission or refraining from sending a PUSCH transmission. The measured quantity value for the SRS-RSRP and the CLI-RSSI measurements can be, for example, measured in terms of a decibel (dB) unit and mapped to actions. The second UE 308 can further determine whether to proceed with transmitting the scheduled PUSCH transmission or refrain from transmitting the scheduled PUSCH transmission based on the measure on the quantity values. In some embodiments, if the measured quantity value is greater than a threshold value (e.g., greater than a threshold dB (XdB)), the second UE 308 can refrain from sending the scheduled PUSCH transmission. If, however, the measured quantity value is less than a threshold value (e.g., less than a threshold dB (XdB)), the second UE 308 can send the scheduled PUSCH transmission. The threshold value can be based on the scheduled PDSCH transmission priority. For example, the second UE 308 can be configured to compare the measured quantity value against a first threshold value for a high priority PDSCH, and a second threshold value for a low priority PDSCH, where the first threshold value is less than the second threshold value. In addition, the second UE 308 can refrain from transmitting a scheduled PUSCH transmission if it collides with a scheduled PDSCH transmission.

In some embodiments, the RAN 304 can provide further indications to the second UE 308. The RAN 304 can indicate if there are a set of symbols or PRBs at which the RAN 304 is operating in a full-duplex mode, and the measured quantity value is greater than a threshold value, the second UE 308 can drop a scheduled PUSCH transmission. The indications can be provided, for example, via group common DCI (GC-DCI) or a UE-specific DCI. Alternatively, the RAN 304 can transmit SRS resource-specific indications to the second UE 308, and the second UE 308 can identify an indication based on a detected SRS resource. In each case, the second UE 308 can map the measured value to an action.

The second UE 308 can transmit the measurement report to the RAN 304, for example, via a medium access control-control element (MAC-CE). For an aperiodic SRS, the transmission of the report is aperiodic. The measurement report can be periodically triggered or triggered based on, for example, a measured quantity value exceeds a threshold value.

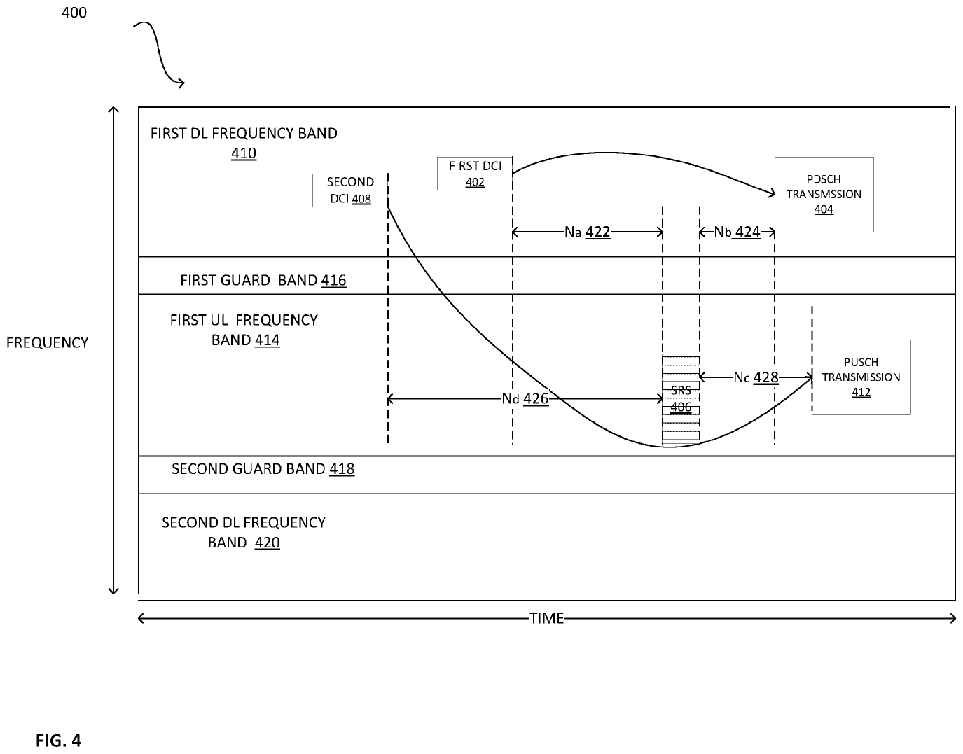

FIG. 4 shows a diagram 400 illustrating timing constraints for using an SRS configured for a CTS purpose according to some embodiments is shown. A RAN (not shown) transmits a first DCI 402 to a first UE (not shown) to schedule a PDSCH transmission 404, to indicate to the first UE to transmit an SRS 406 of a CTS sequence prior to the scheduled PDSCH transmission 404, and provide timing constraints. The base station can be included in the RAN 304 of FIG. 3. The first UE can be the first UE 306 of FIG. 3. The RAN can transmit the first DCI 406 to the first UE over a first DL frequency band 410. The first UE can be scheduled to receive the PDSCH transmission 404 over the first DL frequency band 410. The RAN can transmit a second DCI 408 to a second UE (not shown) to schedule a PUSCH transmission 412, to indicate to measure each SRS (including SRS 406) prior to the scheduled PUSCH transmission 412, and to provide timing constraints. The second UE can be the second UE 308 of FIG. 3. The PUSCH transmission 412 can be scheduled to be transmitted over a first UL frequency band 414. A guard band 416 can separate the first DL frequency band 408 and the first UL frequency band 414. A second guard band 418 can separate the first UL frequency band 414 from a second DL frequency band 420.

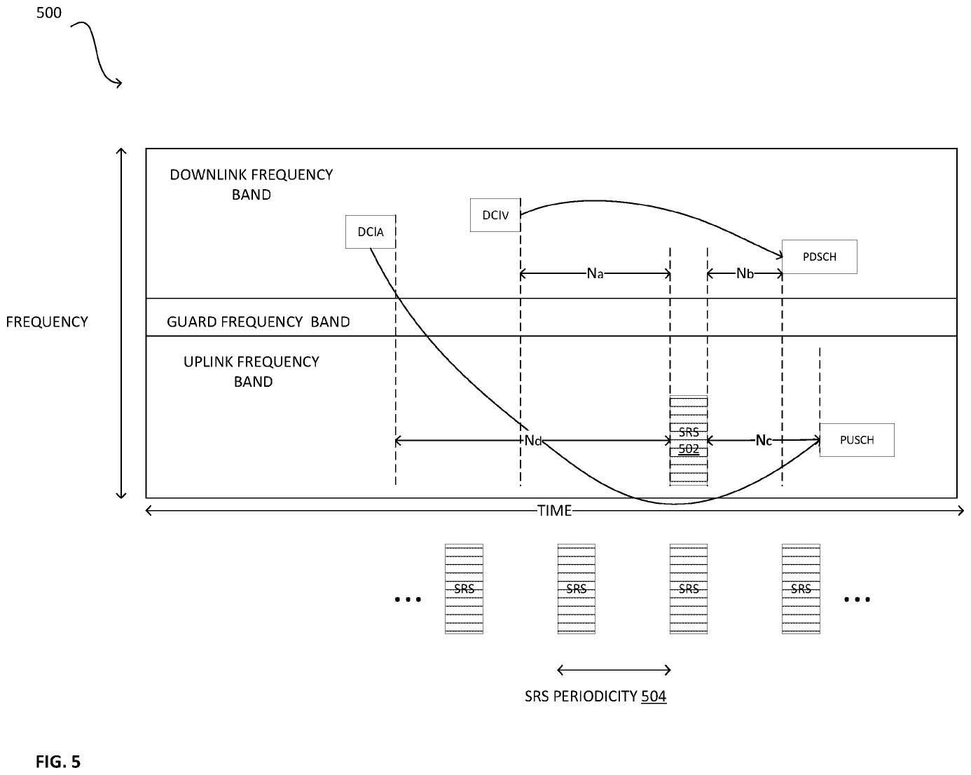

FIG. 5 is a diagram 500 illustrating timing constraints for using an SRS configured for a CTS purpose according to some embodiments. In particular, FIG. 5 is an illustration in which the SRS 502 is an SPS-SRS. The SRS periodicity 504 can be a time interval upon which an SRS will repeat. An SRS period can be from the start of one SRS to the start of the next SRS. For the purpose of brevity, the features described in relation to FIG. 4 can be applied to FIG. 5, with the exception of the SRS 502 being an SPS-SRS.

The timing constraints can indicate that the gap between the last symbol of the first DCI 402 and the SRS 406 is not less than Nₐ 422, where a value of Nₐ 422 is dependent on the first UE's capability; and the smallest subcarrier spacing SCS among the SCSs of the first DCI 402, the SRS 406, and the PDSCH transmission 404. This gap provides the first UE enough time to process the first DCI 402 and transmit the SRS 406 before the scheduled PDSCH transmission. Nₐ can be, for example, the same as 3GPP Technical Specification (TS) 38.214, v17.1.0 (2022Apr. 8) or less (given that the SRS 406 is sent over a small bandwidth).

The timing constraints can indicate that the gap between the last symbol of the second DCI 408 and the first symbol of the SRS 406 is not less than N_{d} 424, where a value of N_{d} 424 depends on the second UE's capability, and the smallest SCS of the SCSs of the second DCI 408, the SRS 406, and the scheduled PUSCH transmission 412. This gap provides the second UE enough time to transmit the second DCI 408 before the transmission of the SRS 406.

The timing constraints can indicate that the gap between the last symbol of the SRS 406 and the first symbol of the scheduled PDSCH 404 is not less than N_{b} 426, where N_{b} 426 depends on the first UE's capability, and the smallest SCS of the SCSs of the first DCI 402, the SRS 406, and the scheduled PDSCH transmission 404. This gap provides the first UE enough time to transmit the SRS before receiving the scheduled PDSCH transmission 404.

The timing constraints can indicate that the gap between the last symbol of the SRS 406 and the first symbol of the scheduled PUSCH transmission 412 is not less than N_{c} 428, where Nc depends on the second UE's capability, and the smallest SCS of the SCSs of the first DCI 402, the SRS 406, and the scheduled PUSCH transmission 412. This gap provides the second UE enough time to measure the SRS 406 prior to the scheduled PUSCH transmission. In some embodiments, the value of N_{c} can be T_{proc,2} and additional symbols.

The SRS 406 configured to the CTS purpose can be transmitted for measurement by any potential aggressor UEs (including the second UE) that are spatially correlated to the first UE. The timing advance applied by a potential victim UE for transmission of the SRS may be based on a given offset to DL transmission time.

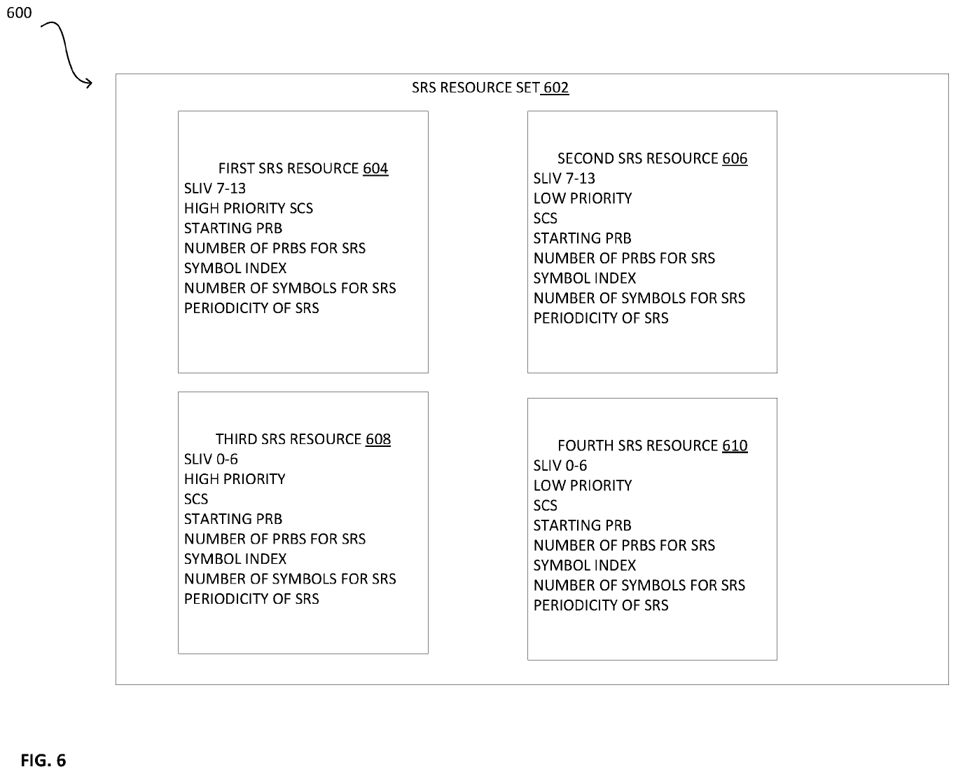

FIG. 6 is an illustration 600 of an SRS resource set 602 that includes a first SRS resource 604, a second SRS resource 606, a third SRS resource 608, and a fourth SRS resource 610. It should be appreciated that the SRS resource set 602 includes four SRS resources for illustration purposes, and could be greater than four SRS resources or less than four SRS resources. As described above, each SRS resource in the SRS resource set 602 can be respectively configured.

As illustrated in FIG. 6, each SRS resource is respectively configured. For brevity, the first SRS resource 604 is described. It should be appreciated that each of the second SRS resource 606, the third SRS resource 608, and the fourth SRS resource 610 can be configured to include information relating to a scheduled PDSCH transmission. For example, the first resource 604 can be configured in terms of the SCS of the SRS, a starting PRB of the SRS, a number of PRBs for the SRS transmission, a symbol index, a number of symbols for the SRS transmission, and a periodicity of the SRS transmission.

A first UE, such as the first UE 306 of FIG. 3, can have several opportunities to transmit an SRS over one of SRS resources of the SRS resource set 602 between the last symbol of a first DCI, such as the first DCI 402 of FIG. 4, and a scheduled PDSCH transmission, such as the scheduled PDSCH transmission 404 of FIG. 4. The first UE can transmit the SRS, such as SRS 406 of FIG. 4, at the first available opportunity after the last symbol of the first DCI. This is provided that the gap between the last symbol of the first DCI and the SRS is not less than Nₐ as described with respect to FIG. 4. This is further provided that the gap between the last symbol of the SRS and the first symbol of the scheduled PDSCH is not less than N_{b} as described with respect to FIG. 4. Prior to sending the SRS, the first UE can determine whether the time duration (i.e., gap) conditions for Nₐ and N_{b} described with respect to FIG. 4 are met. For example, the first UE can identify the first opportunity to transmit the SRS. The first UE can then determine whether the gap between the last symbol of the first DCI and the SRS is not less than Nₐ. The first UE can also determine whether the gap between the last symbol of the SRS and the first symbol of the scheduled PDSCH is not less than N_{b}. If these conditions are met, the first UE can transmit the SRS. If, however, one of the conditions is not met, the first UE can identify the second opportunity to transmit the SRS and check if the gap conditions are met. A second UE, such as the second UE 308 of FIG. 3, can detect a possible SRS transmission based on an SRS transmission periodicity. This is provided that the gap between the last symbol of the SRS 406 and the first symbol of the scheduled PUSCH transmission 412 is not less than N_{c} as described with respect to FIG. 4. This is further provided that the gap between the last symbol of the second DCI 408 and the first symbol of the SRS 406 is not less than N_{d} as described with respect to FIG. 4.

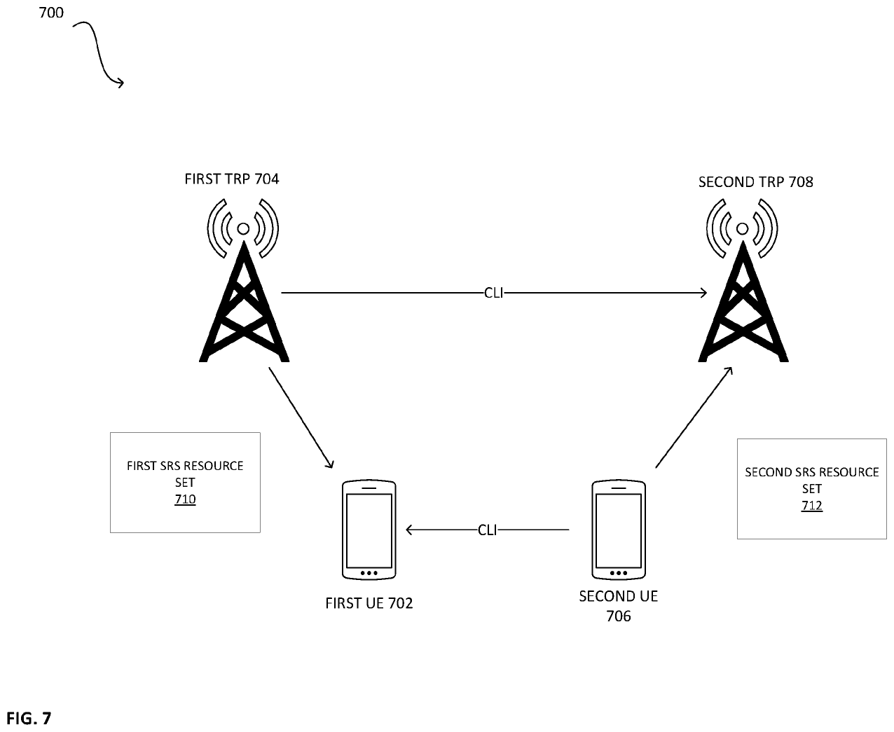

FIG. 7 illustrates different CTS scenarios 700. It should be appreciated that in many instances, a transmission and reception point (TRP) is serving a potential victim UE in the same cell as the potential aggressor UE. However, in some instances, a first UE 702 can be scheduled to receive a PDSCH transmission from a first TRP 704, wherein the first TRP 702 and the TRP 704 are in a first cell of a network. A second UE 706 can be scheduled to send a PUSCH transmission to a second TRP 708. The second UE 706 and the second TRP 708 can be in a neighboring second cell of the network. Even in a scenario such as this, the scheduled PUSCH transmission can interfere with the scheduled PDSCH transmission. The herein-described techniques can be applied to a scenario in which the first UE 702 and the first TRP 704 are in a first cell of a network, and the second UE 706 and the TRP 708 are in a second cell of the network. In this scenario, a first SRS resource set 710 associated with the first cell is configured the same as a second SRS resource set 712 associated with the second cell. In this sense, the second UE 706 can detect that the SRS is configured for a CTS purpose, even though the SRS was transmitting using an SRS resource configured by a TRP of a neighboring cell.

The above-described techniques have related to a CLI experienced between a potential victim UE and potential aggressor UE. It should be appreciated that, the potential victim UE is the UE scheduled to receive a transmission, and the potential aggressor UE is the UE scheduled to send a transmission. With respect to base stations, the potential victim base station is the base station scheduled to receive the transmission, and the potential aggressor base station is the base station scheduled to send the transmission.

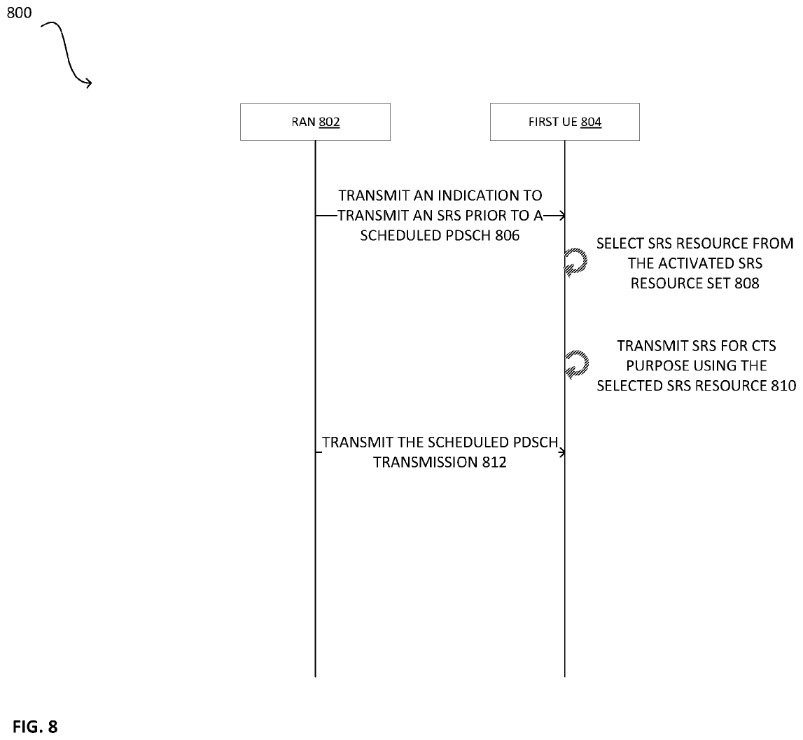

FIG. 8 illustrates a signaling diagram 800 for transmitting an SRS for a CTS purpose. As illustrated, a RAN 802 can be in communication with a first UE 804. At 806, the RAN 802 can transmit an indication to transmit an SRS prior to a scheduled PDSCH transmission. The scheduled PDSCH transmission can include a transmission parameter such as a SLIV, a priority, a timing advance, and a number of repetitions. In some embodiments, the indication is transmitted via the DCI, for example, the DCI that schedules the PDSCH transmission. In other embodiments, the indication is sent via a RRC transmission.

At 808, the first UE 804 can select an SRS resource from an SRS activated resource set to use to transmit the SRS. The SRS resource set can be activated based on the DCI, or in other instances, an RRC flag. The first UE 804 can be configured with SRS resource, such that the SRS resources are configured to carry information related to the scheduled PDSCH. Each SRS resource of the activated SRS resource set can respectively carry information related to the scheduled PDSCH transmission. For example, one SRS resource can carry a parameter that indicates that the scheduled PDSCH transmission is a high priority PDSCH transmission, whereas another SRS resource can carry an indication that the scheduled PDSCH transmission is a low priority PDSCH transmission. The first UE 804 can select the SRS resource based on the parameter of the scheduled PDSCH relating to the parameter of the SRS resource.

At 810, the first UE 804 can transmit the SRS using the selected SRS resource from the activated SRs resource set. In some embodiments, the RAN 802 can transmit timing constraints for transmitting the SRS. Therefore, the first UE 804 can transmit the SRS based on the timing constraints. The timing constraints can include a minimum gap between the last symbol of the step 806 transmission and the first symbol of the SRS. The timing constraints can further include a minimum gap between the last symbol of the SRS and the first symbol of the scheduled PDSCH transmission.

At 812, the RAN 802 can transmit the scheduled PDSCH transmission. The first UE 804 can receive the scheduled PDSCH transmission.

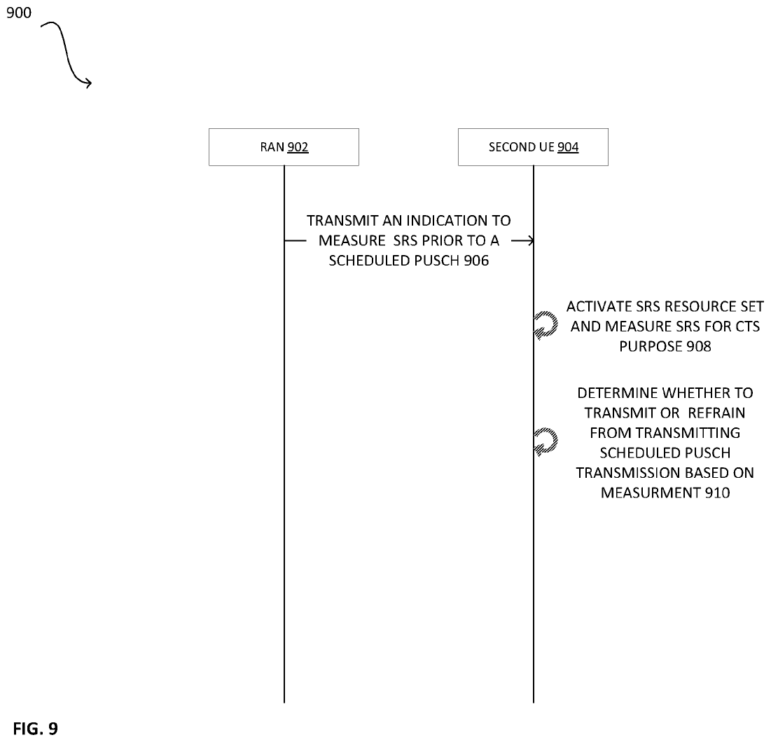

FIG. 9 illustrates a signaling diagram 900 for determining whether to proceed with or refrain from transmitting a scheduled PUSCH transmission. As illustrated, a RAN 902 can be in communication with a second UE 904. A base station of the RAN 902 that schedules the PUSCH can be the same base station that schedules the PDSCH referenced in FIG. 8, or the base station that schedules the PUSCH can be a different base station. The second UE 904 can be in the same cell as the first UE 804 of FIG. 8, or the second UE 904 can be in a cell that neighbors the cell of the first UE 804.

At 906, the RAN 902 can send an indication to measure an SRS prior to a scheduled PUSCH transmission. In some embodiments, the indication can be transmitted via DCI, for example, the DCI that schedules the PUSCH transmission. In other embodiments, the indication can be transmitted via an RRC transmission. The SRS can have been transmitted by a first UE, such as the first UE 804. At 908, the second UE 904 can activate an SRS resource set and measure the SRS. The second UE 904 can use various techniques to measure the SRS, such as CLI-RSSI or SRS-RSRP. It should be appreciated that in some embodiments, the first UE transmits an SRS over one SRS resource of an activated SRS resource set, whereas the second UE 904 measures over each SRS resource of an activated SRS resource set. This is due to the possibility that multiple UEs have transmitted an SRS over a respective SRS resource prior to their scheduled PDSCH transmission.

In some embodiments, the RAN 902 can further transmit timing constraints for measuring the SRS transmitted by the first UE. Therefore, the second UE 904 can transmit the SRS based on the timing constraints. The timing constraints can include a minimum gap between the last symbol of the step 906 transmission and the first symbol of the SRS. The timing constraints can further include a minimum gap between the last symbol of the SRS and the first symbol of the scheduled PUSCH transmission.

At 906, the second UE 904 can determine whether to proceed with the scheduled PUSCH transmission or refrain from transmitting the scheduled PUSCH transmission. The second UE 904 can use the measurement to determine whether the scheduled PUSCH transmission interferes with a scheduled PDSCH transmission. If the measurement indicates that the scheduled PUSCH transmission interferes with a scheduled PDSCH transmission, the second UE 904 can refrain from sending the scheduled PUSCH transmission. If, however, the measurement indicates that the scheduled PUSCH does not interfere with a scheduled PDSCH, then the second UE 904 can send the scheduled PUSCH transmission.

In some embodiments, the RAN 902 can further send an indication to map the measurement to an action, such as sending or refraining from sending a scheduled PUSCH transmission. The RAN 902 can further indicate one or more threshold values for determining whether to proceed or refrain from sending a scheduled PUSCH transmission. The indicated thresholds can further be based on a priority of scheduled PDSCH transmission. For example, one threshold for a high priority PDSCH transmission and another threshold for a low priority PDSCH transmission.

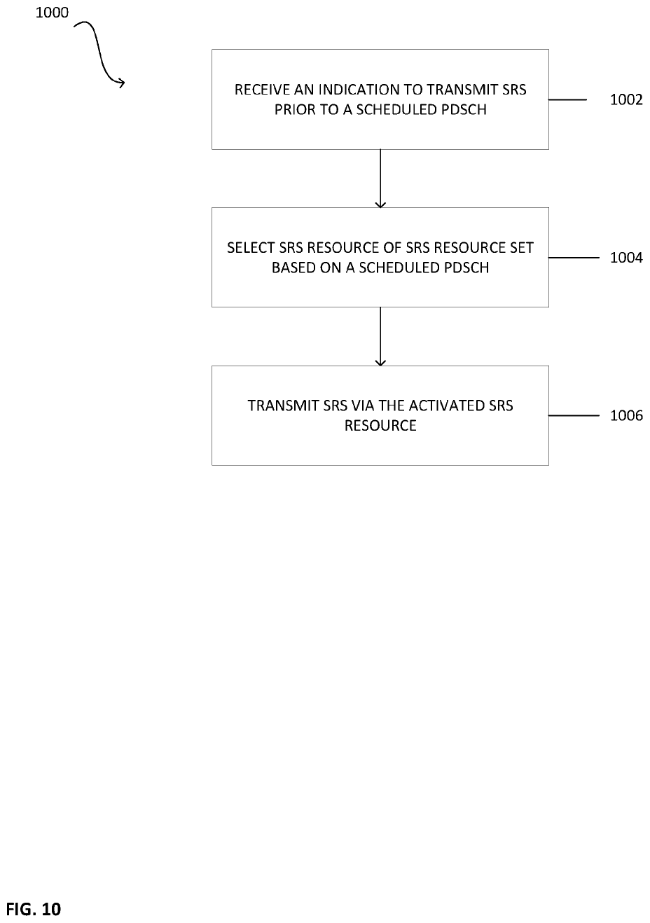

FIG. 10 illustrates a process 1000 for transmitting an SRS for a CTS purpose. At 1002, a first UE can receive an indication to transmit an SRS prior to a scheduled PDSCH. The indication can be received from a RAN and via the DCI that scheduled the PDSCH. In some embodiments, the DCI can include an SRS bit-field that indicates that the SRS is for a CTS purpose. In other embodiments, the first UE receives an RRC flag that indicates that the SRS is for a CTS purpose.

At 1004, the first UE can select an SRS resource from an SRS activated resource set to use to transmit the SRS. The SRS resource set can be activated based on SRS bit-field of the DCI, or in other embodiments the RRC flag. Each SRS resource of the activated SRS resource set can respectively carry information related to scheduled PDSCH transmission. The first UE can make the selection of the SRS resource based on the parameter of the scheduled PDSCH relating to the parameter of the SRS resource of the activated SRS resource set.

At 1006, the first UE can transmit the SRS using the selected SRS resource from the activated SRs resource set. In some embodiments, the first UE can receive timing constraints for transmitting the SRS. The first UE can transmit the SRS based on the received timing constraints. The first UE transmit the SRS and then receive the scheduled PDSCH transmission. It should be appreciated that the first UE can transmit the SRS over a single SRS resource of the activated SRS resource set, rather than transmitting an SRS over each SRS resource of the activated SRS resource set.

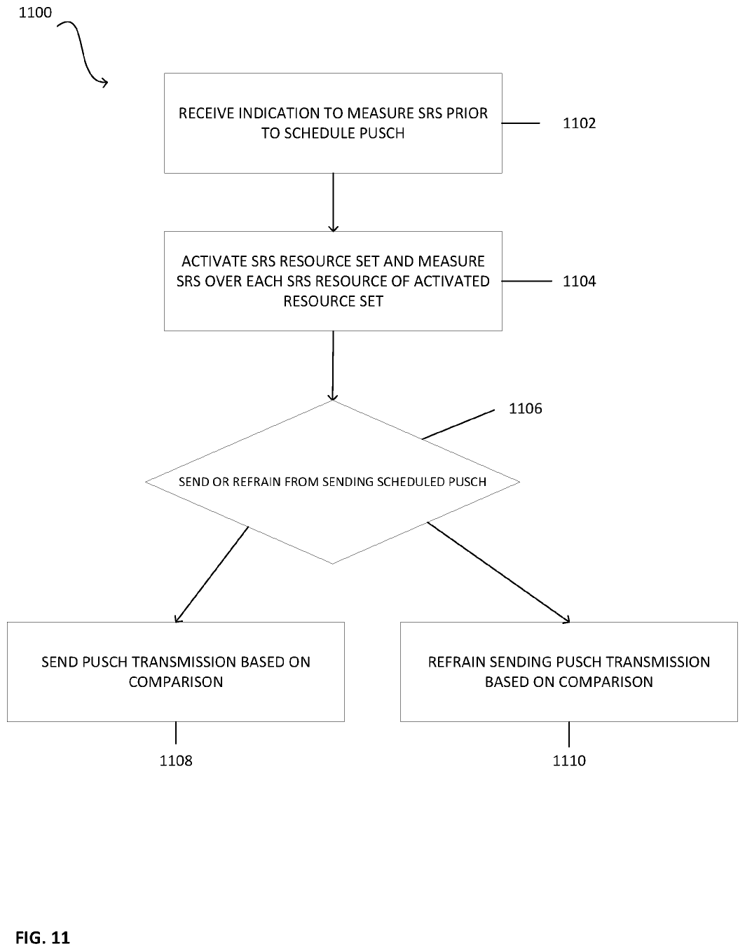

FIG. 11 illustrates a method 1100 for determining whether to send a PUSCH transmission or refrain from sending a PUSCH transmission. At 1102, a second UE can receive an indication to measure an SRS prior to a scheduled PUSCH transmission. In some embodiments, the indication can be transmitted via the DCI such as the DCI that schedules the PUSCH transmission. In other embodiments, the indication can be transmitted via an RRC parameter. At 1104, the second UE can activate an SRS resource set and measure the SRS via various techniques such as CLI-RSSI or SRS-RSRP. It should be appreciated that the second UE measures an SRS over each SRS resource of an activated SRS resource set. This is due to the possibility that multiple UEs can have transmitted an SRS over a respective SRS resource prior to their scheduled PUSCH transmission. In some embodiments, the second UE further receives timing constraints for measuring the SRS. Therefore, the second UE can measure an SRS transmission based on the timing constraints.

At 1106, the second UE can compare the measured value to a threshold value. The second UE 904 can use the measurement to determine whether the scheduled PUSCH transmission interferes with a scheduled PDSCH transmission. The threshold value can be based on a priority of the scheduled PDSCH transmission value. Therefore, the second UE can compare the measured value a first threshold value for a high priority PDSCH transmission or a second threshold value for a low priority PDSCH transmission.

In some embodiments, the RAN 902 can further send an indication to map the measurement to an action, such a proceeding or refraining from sending a scheduled PUSCH transmission. The RAN 902 can further indicate one or more threshold values for determining whether to proceed or refrain from sending a scheduled PUSCH transmission. The indicated thresholds can further be based on a priority of scheduled PDSCH transmission. For example, one threshold for a high priority PDSCH transmission and another threshold for a low priority PDSCH transmission. In addition, depending on the information carried by the SRS, the second UE can refrain from sending the scheduled PUSCH transmission if it collides the scheduled PDSCH transmission. In other instances, the indication can be that a base station is operating in a full-duplex mode at a certain set of symbols or PRBs. In this instance, the second UE can refrain from sending the scheduled PUSCH transmission over an indicated resource if the measured value is greater than a threshold value. Alternatively, different SRS resources of an activated resource set can correlate to different PDSCH transmission durations, and the second UE can refrain from sending a scheduled PUSCH transmission based using a scheduled PDSCH transmission duration to determine that the scheduled PUSCH transmission interferes with the scheduled PDSCH transmission.

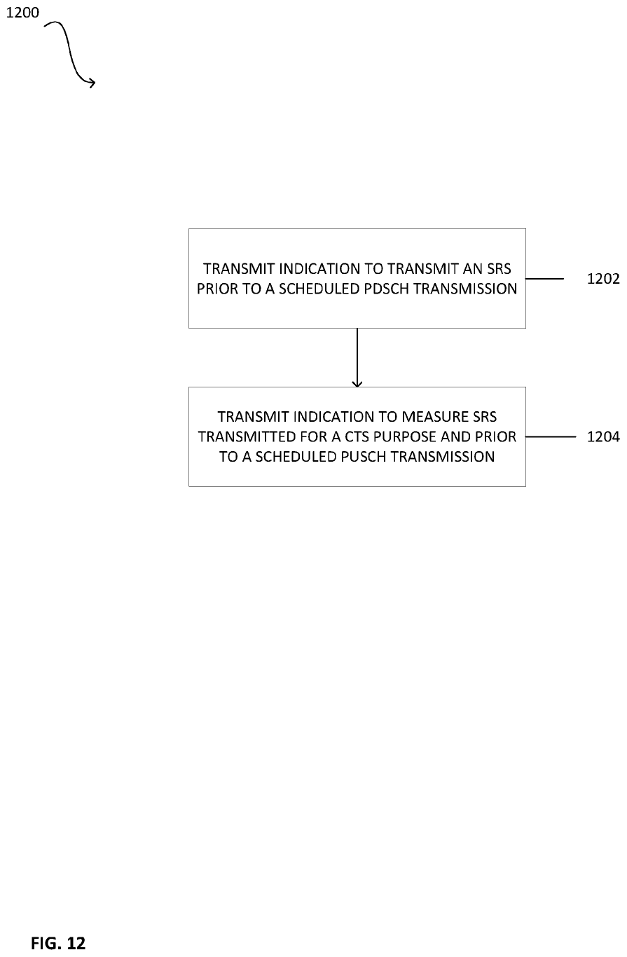

FIG. 12 illustrates a process 1200 for providing CTS-related indications according to some embodiments. At 1202, a RAN can transmit an indication to transmit an SRS prior to a scheduled PDSCH transmission. The RAN can transmit the indication, for example, via an SRS bit-field of DCI that schedules the PDSCH transmission. Alternatively, the RAN can transmit the indication via an RRC flag. In addition to the indication to transmit the SRS, the RAN can transmit timing constraints for the transmission of the SRS. The timing constraints can include a minimum gap between the last symbol of the transmission that provided the indication and the first symbol of the SRS. The timing constraints can further include a minimum gap between the last symbol of the SRS and the first symbol of the scheduled PDSCH transmission.

At 1204, the RAN can transmit an indication to measure the SRS prior to a scheduled PUSCH transmission. The RAN can further transmit timing constraints for measuring the SRS. The timing constraints can include a minimum gap between the last symbol of the transmission that provided the indication and the first symbol of the SRS. The timing constraints can further include a minimum gap between the last symbol of the SRS and the first symbol of the scheduled PUSCH transmission. It should be appreciated that this step can be performed by the base station of the RAN that performs step 1202 or a base station in a neighboring cell.

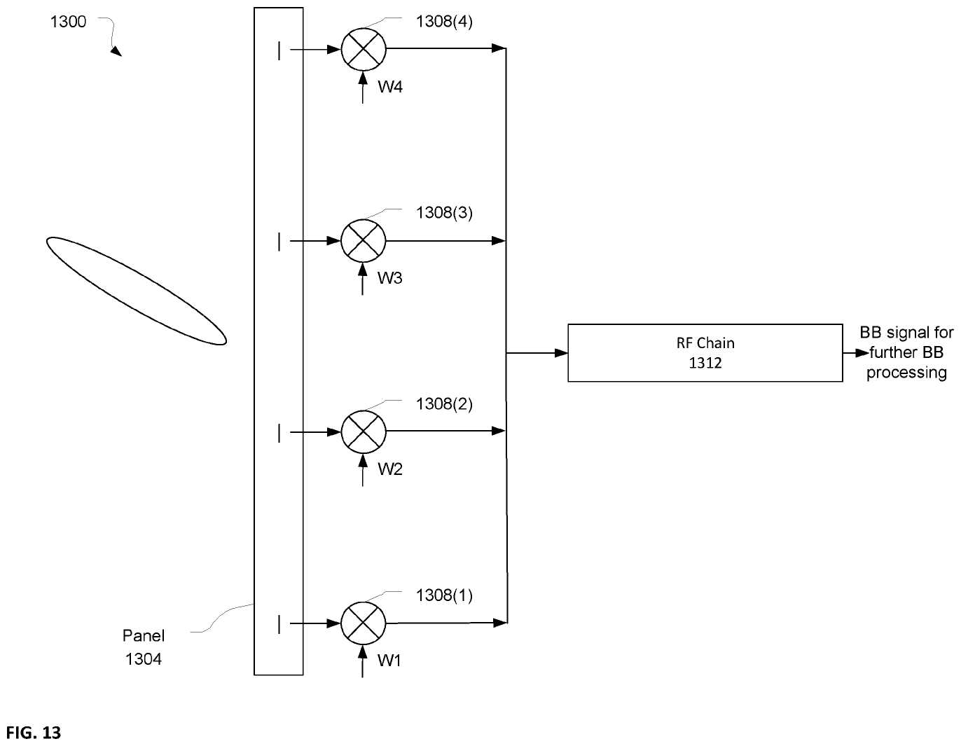

FIG. 13 illustrates receive components 1300 of the UE 106 of FIG. 1, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1)-1308(4) may be coupled with a radio-frequency (RF) chain 1312. The RF chain 1312 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example, W1-W4), which may represent phase shift values, to the phase shifters 1308(1)-1308(4) to provide a receive beam at the antenna panel 1304. These BF weights may be determined based on the channel-based beamforming.

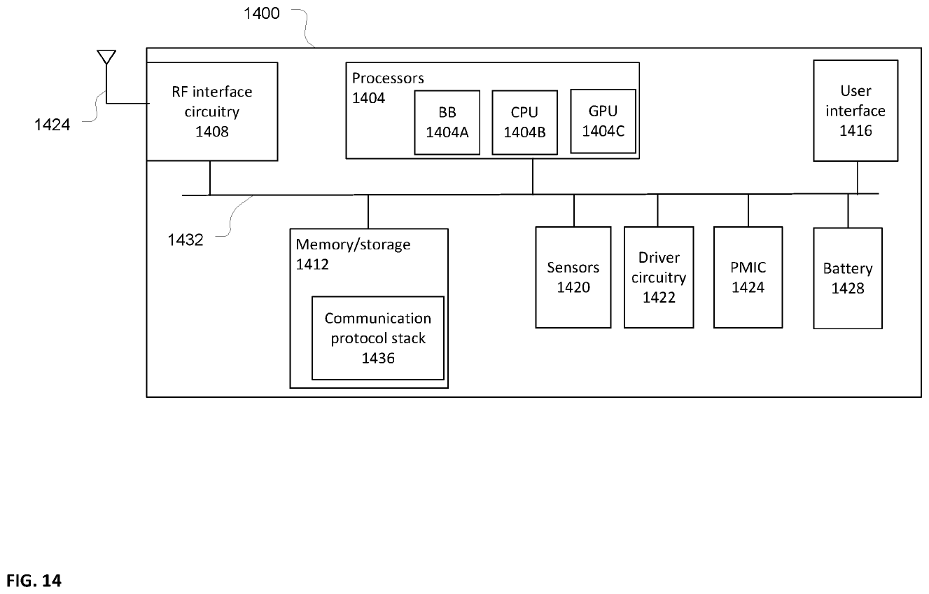

FIG. 14 illustrates a UE 1400, in accordance with some embodiments. The UE 1400 may be similar to and substantially interchangeable with UE 106 of FIG. 1.

Similar to that described above with respect to UE 106, the UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry, such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1600 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information 1424 from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1424 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1424.

In various embodiments, the RF interface circuitry 1408 may be configured to transmit/receive signals in a manner compatible with NR access technologies.

The antenna 1424 may include a number of antenna elements that each convert electrical signals into radio waves to travel through the air and to convert received radio waves into electrical signals. The antenna elements may be arranged into one or more antenna panels. The antenna 1424 may have antenna panels that are omnidirectional, directional, or a combination thereof to enable beamforming and multiple input, multiple output communications. The antenna 1424 may include microstrip antennas, printed antennas fabricated on the surface of one or more printed circuit boards, patch antennas, phased array antennas, etc. The antenna 1424 may have one or more panels designed for specific frequency bands, including bands in FR1 or FR2 .

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in their environment and transmit the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations, such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples, the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

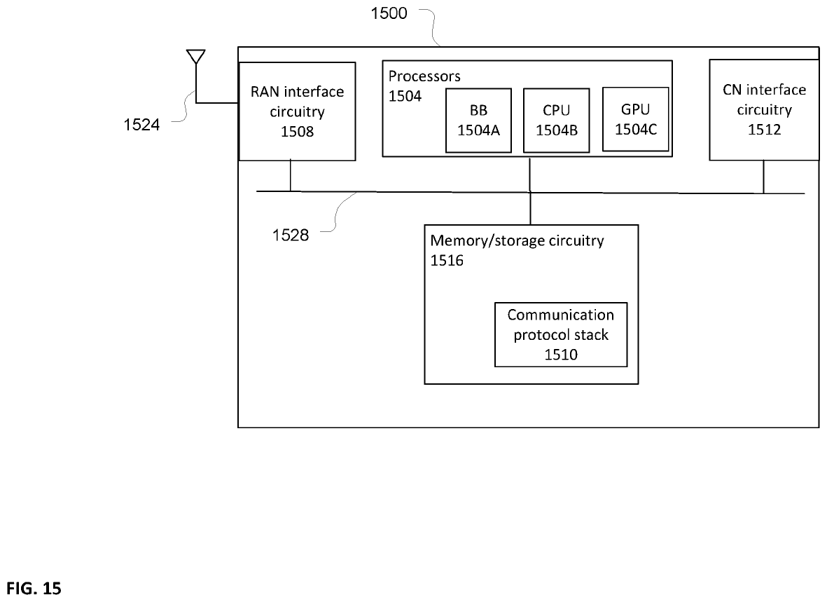

FIG. 15 illustrates a gNB 1500, in accordance with some embodiments. The gNB node 1500 may be similar to and substantially interchangeable with the base station 104 of FIG. 1.

The gNB 1500 may include processors 1504, RF interface circuitry 1508, core network (CN) interface circuitry 1512, and memory/storage circuitry 1516.

The components of the gNB 1500 may be coupled with various other components over one or more interconnects 1528.

The processors 1504, RF interface circuitry 1508, memory/storage circuitry 1516 (including communication protocol stack 1510), antenna 1524, and interconnects 1528 may be similar to like-named elements shown and described with respect to FIG. 13.

The CN interface circuitry 1512 may provide connectivity to a core network, for example, a 5th Generation Core network (5GC) using a 5GC-compatible network interface protocol, such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a network, the method comprising: receiving an indication to transmit a sounding reference signal (SRS) prior to a physical downlink shared channel (PDSCH) transmission, wherein the PDSCH transmission is scheduled with a first transmission parameter that is a start and length indicator value (SLIV), a priority, a timing advance, or a number of repetitions; selecting, from an activated SRS resource set, an SRS resource that has a second transmission parameter that is associated with the first transmission parameter; and transmitting the SRS via the SRS resource.

Example 2 includes the method of example 1, wherein the indication is provided in an SRS request field in downlink control information (DCI) that schedules the PDSCH transmission, and the method further comprises activating the SRS resource set based on the SRS request field.

Example 3 includes the method of any of examples 1 and 2, wherein the method further comprises receiving radio resource control (RRC) signaling to configure the SRS resource set with a clear-to-send (CTS) purpose.

Example 4 includes the method of any of examples 1-3, wherein the method further comprises: determining that the second transmission parameter is associated with the first transmission parameter; and selecting the SRS resource from the activated SRS resource set based on said determination that the second transmission parameter is associated with the first transmission parameter.

Example 5 includes the method of any of examples 1-4, wherein the PDSCH transmission is a semi-persistently scheduled (SPS) PDSCH transmission, and the method further comprises transmitting a periodic SRS based on the SPS PDSCH transmission.

Example 6 includes a method implemented by a network, the method comprising: receiving, by a first node of the network, an indication to measure a sounding reference signal (SRS) prior to transmitting a scheduled physical uplink shared channel (PUSCH) transmission; measuring, by the first node of the network, the SRS to obtain a measurement value; and determining, by the first node of the network, based on the measurement value, whether the scheduled PUSCH transmission is to interfere with a scheduled physical downlink shared channel (PDSCH) transmission of a second network node of the network.

Example 7 includes the method of example 6, wherein the indication is provided in downlink control information (DCI) that schedules the PUSCH transmission, and the method further comprises activating an SRS resource set for measurement based on the indication.

Example 8 includes the method of example 7, wherein the method further comprises; measuring an SRS resource of the SRS resource set to determine a transmission parameter of the scheduled PDSCH transmission based on the SRS resource, and determining whether the scheduled PDSCH transmission is to interfere with the scheduled PUSCH transmission based on the transmission parameter, wherein the transmission parameter is a start and length indicator value (SLIV), a priority, a timing advance, or a number of repetitions.

Example 9 includes the method of any of examples 6-8, wherein the transmission parameter is a priority, and the method further comprises: determining a threshold measurement value based on the priority; comparing the measurement value to the threshold measurement value; and determining whether the scheduled PDSCH transmission is to interfere with the scheduled PUSCH transmission based on said comparing.

Example 10 includes the method of any of examples 6-9, wherein the method further comprises measuring the SRS via an SRS reference signal received power (SRS-RSRP) technique.

Example 11 includes the method of examples 7-10, wherein the method further comprises: comparing the measurement value to a threshold measurement value; and determining whether the scheduled PDSCH transmission is to interfere with the scheduled PUSCH transmission based on said comparison.

Example 12 includes the method of any of examples 6-11, wherein the method further comprises: comparing a time interval of the scheduled PDSCH and a time interval of the scheduled PUSCH; and transmitting the scheduled PUSCH based on the comparison.

Example 13 includes the method of any of examples 6-12, wherein the first node of the network is in a first cell of the network, and wherein the second node of the network is in a second cell of the network.

Example 14 includes the method of any of examples 6-13, wherein the SRS resource set is tagged with a radio resource control (RRC) flag, the RRC flag indicating that the SRS resource set is for a clear to send purpose (CTS), and the method further comprises measuring the SRS to obtain the measurement value based on the RRC flag.

Example 15 includes the method of any of examples 6-14, wherein the method further comprises reporting the measurement value to a base station based on a periodic trigger or a threshold-based trigger.

Example 16 includes a method implemented by a network, the method comprising: transmitting a first indication to a first user equipment (UE) to transmit a first sounding reference signal (SRS) prior to a first scheduled physical downlink shared channel (PDSCH); and transmitting a second indication to a second UE to determine whether to send a scheduled physical uplink shared channel (PUSCH) transmission or refrain from sending the PUSCH transmission based on a measurement of the SRS.

Example 17 includes the method of example 16, wherein the first indication is transmitted by a first base station of a first cell of the network, and the second indication is transmitted by a second base station of a second cell of the network.

Example 18 includes the method of any examples 16 and 17, wherein the method further comprises configuring an SRS resource of an SRS resource set to include a parameter relating to the scheduled PDSCH, and wherein the SRS is transmitted via the SRS resource.

Example 19 includes the method of any of examples 16-18, wherein the method further comprises transmitting a timing constraint to the first UE, and wherein the timing constraint includes a minimum gap between the last symbol of the SRS and the first symbol of the scheduled PDSCH transmission.

Example 20 includes the method of any of examples 16-19, wherein the method further comprises transmitting a timing constraint to the second UE, and wherein the timing constraint includes a minimum gap between the last symbol of the SRS and the first symbol of the scheduled PUSCH transmission.

Example 21 includes the method of any of examples 1-5, wherein the SRS resource is configured with respect to a subcarrier spacing (SCS), a starting physical resource block (PRB), a number of PRBs for a transmission of the SRS, a symbol index, a number of symbols for the transmission of the SRS, or a periodicity of the transmission of the SRS.

Example 22 includes the method of any of examples 8-15, wherein the SRS resource is configured with respect to an SCS, a starting PRB, a number of PRBs for a transmission of the SRS, a symbol index, a number of symbols for the transmission of the SRS, or a periodicity of the transmission of the SRS.

Example 23 includes the method of any of examples 16-20, wherein the method further comprises configuring an SRS resource with respect to an SCS, a starting PRB, a number of PRBs for a transmission of the SRS, a symbol index, a number of symbols for the transmission of the of the SRS, or a periodicity of the transmission of the SRS.

Example 24 includes the method of any of examples 1-5 and 21, wherein the method further comprises: determining, at a first opportunity to transmit the SRS, whether a transmission of the SRS is to collide with an uplink (UL) transmission or a downlink (DL) transmission; and determining whether to transmit the SRS based on the determination of whether the transmission of the SRS is to collide with a UL transmission or a DL transmission.

Example 25 includes the method of any of examples 1-5, 21, and 24, wherein the method further comprises: determining, at a second opportunity to transmit the SRS, whether there is to be a minimum gap between the last symbol of a transmission that indicates to transmit the SRS and the first symbol of the SRS; and determining whether to transmit the SRS at the second opportunity based on the determination of whether there is to be a minimum gap between the last symbol of a transmission that indicates to transmit the SRS and the first symbol of the SRS.

Example 26 includes the method of any of examples 6-15 and 22, wherein the method further comprises detecting the SRS to measure based on a periodicity of the transmission of the SRS.

Example 27 includes a system comprising means to perform one or more elements of a method described in or related to examples 1-26.

Example 28 includes a non-transitory computer-readable media comprising instructions to cause a network, upon execution of the instructions by one or more processors of the network, to perform one or more elements of a method described in or related to any of examples 1-26.

Example 29 includes a network comprising logic, modules, or circuitry to perform one or more elements of a method described in or related to any of examples 1-26.

Example 30 includes a network, comprising: one or more processors and one or more computer-readable media comprising instructions to cause a network, upon execution of the instructions by one or more processors of the network, to perform one or more elements of a method described in or related to any of examples 1-26.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure if fully appreciated. It is intended that the following claims be interpreted to embrace all such variations and modifications.

1.-25. (canceled)

26. A method comprising:
receiving an indication to transmit a sounding reference signal (SRS) prior to a physical downlink shared channel (PDSCH) transmission, wherein the PDSCH transmission is scheduled with a first transmission parameter that is a start and length indicator value (SLIV), a priority, a timing advance, or a number of repetitions;
selecting, from an activated SRS resource set, an SRS resource that has a second transmission parameter that is associated with the first transmission parameter; and
outputting the SRS for transmission via the SRS resource.

27. The method of claim 26, wherein the indication is provided in an SRS request field in downlink control information (DCI) that schedules the PDSCH transmission, and wherein the method further comprises activating the SRS resource set based on the SRS request field.

28. The method of claim 26, wherein the method further comprises receiving radio resource control (RRC) signaling to configure the SRS resource set with a clear-to-send (CTS) purpose.

29. The method of claim 26, wherein the method further comprises:
determining that the second transmission parameter is associated with the first transmission parameter; and
selecting the SRS resource from the activated SRS resource set based determining that the second transmission parameter is associated with the first transmission parameter.

30. The method of claim 26, wherein the PDSCH transmission is a semi-persistently scheduled (SPS) PDSCH transmission, and wherein the method further comprises transmitting a periodic SRS based on the SPS PDSCH transmission.

31. The method of claim 26, wherein the SRS resource is configured with respect to a subcarrier spacing (SCS), a starting physical resource block (PRB), a number of PRBs for a transmission of the SRS, a symbol index, a number of symbols for the transmission of the SRS, or a periodicity of the transmission of the SRS.

32. The method of claim 26, wherein the method further comprises:
determining, at a first opportunity to transmit the SRS, whether a transmission of the SRS is to collide with an uplink (UL) transmission or a downlink (DL) transmission; and
determining whether to transmit the SRS based on the determination of whether the SRS is to collide with the UL transmission or the DL transmission.

33. The method of claim 32, wherein the method further comprises:
determining, at a second opportunity to transmit the SRS, whether there is to be a minimum gap between a last symbol of a transmission that indicates to transmit the SRS and a first symbol of the SRS; and
determining whether to transmit the SRS at the second opportunity based on the determination of whether there is to be the minimum gap between the last symbol of the transmission that indicates to transmit the SRS and the first symbol of the SRS.

34. An apparatus of a first user equipment (UE) comprising:
processor circuitry to:
process an indication to measure a sounding reference signal (SRS) prior to a communication, the indication received via first downlink control information (DCI) scheduling the communication, and determine a timing gap associated with the SRS based on the DCI; and
interface circuitry coupled with the processor circuitry to enable communication.

35. The apparatus of claim 34, wherein the communication is a physical downlink shared channel (PDSCH) communication, and wherein the timing gap is a between a last symbol of the DCI scheduling the PDSCH communication and a first symbol of the SRS.

36. The apparatus of claim 35, wherein the timing gap is based on a smallest subcarrier spacing (SCS) of a DCI SCS, an SRS SCS, or a PDSCH communication SCS.

37. The apparatus of claim 34, wherein the communication is a physical uplink shared channel (PUSCH) communication, and wherein the timing gap is a between a last symbol of the DCI scheduling the PUSCH communication and a first symbol of the SRS.

38. The apparatus of claim 37, wherein the timing gap is based on a smallest SCS of a DCI SCS, an SRS SCS, or a PUSCH communication SCS.

39. The apparatus of claim 34, wherein the communication is a PDSCH communication, and wherein the timing gap is a between a last symbol of the SRS and a first symbol of the PDSCH communication.

40. The apparatus of claim 39, wherein the timing gap is based on a smallest SCS of a DCI SCS, an SRS SCS, or a PUSCH communication SCS.

41. The apparatus of claim 34, wherein the communication is a PUSCH communication, and wherein the timing gap is a between a last symbol of the SRS and a first symbol of the PUSCH communication.

42. The apparatus of claim 34, wherein the apparatus is a first apparatus, wherein the timing gap is zero, and wherein the processor circuitry is further to:
determine a duration of the SRS based on a capability of a second apparatus of a second UE.

43. One or more non-transitory, computer-readable media comprising instructions that, when executed, cause processor circuitry to:
process sounding reference signal (SRS) configuration information that includes sub-carrier spacing (SCS) information, physical resource block (PRB) information, symbol information, and SRS periodicity information;
determine a gap between a last symbol of downlink control information (DCI) and a first symbol of an SRS opportunity meets a condition, wherein the DCI indicates to transmit the SRS; and
cause an SRS to be transmitted based on determination that the gap meets the condition.

44. The one or more non-transitory, computer-readable media of claim 43, wherein the SRS opportunity is a second SRS opportunity, and wherein the instructions that, when executed, further cause the processor circuitry to:
determine that a first SRS opportunity collides with an uplink (UL) or downlink (DL) communication; and
determine to transmit the SRS at the second SRS opportunity based on

45. The one or more non-transitory, computer-readable media of claim 44, wherein the SRS is detectable based on an SRS periodicity.
